(19) United States
(12) Patent Application Publication
(10) Pub. No.: US 2006/0173149 A1
(43) Pub. Date: Aug. 3, 2006

(54) Method for producing polymers having isotactic or syndiotactic regions

(75) Inventors: Reinhold J. Leyrer, Dannstadt (DE); Bettina Muller, Mannheim (DE); Patrick Amrhein, Hochheim (DE); Gunnar Schornick, Neuleiningen (DE); Helmut Ritter, Wuppertal (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/548,191

(22) PCT Filed: Mar. 19, 2004
(86) PCT No.: PCT/EP04/02876

§ 371 Date: Sep. 7, 2005

(30) Foreign Application Priority Data
Mar. 20, 2003 (DE) 103125094

(51) Int. Cl. C08F 118/02

(52) U.S. Cl. 526/319

(57) ABSTRACT

A process for preparing a polymer having isotactic or syndiotactic regions (ordered regions for short) by polymerizing polymerizable compounds (monomers) in the presence of an optically active compound as complexing agent, wherein more than 50% by weight of the optically active compound is in the form of only one of the possible enantiomers, the polymerization takes place at temperatures below 20° C., and at least 10% by weight of the monomers are prochiral compounds.

The invention relates to a process for preparing polymers having isotactic or syndiotactic regions (ordered regions for short) by polymerizing polymerizable compounds (monomers) in the presence of an optically active compound as complexing agent, wherein
more than 50% by weight of the optically active compound is in the form of only one of the possible enantiomers,
the polymerization takes place at temperatures below 20° C., and
at least 10% by weight of the monomers are prochiral compounds.

The invention also relates to polymers obtainable by this process and to the use of these polymers.

DE-A-19533269 and U.S. Pat. No. 5,521,266 disclose a process of free-radical polymerization of sparingly water-soluble or water-insoluble monomers in aqueous systems. That process uses cyclodextrin as a complexing agent.

The use of noncyclic polysaccharides as complexing agents is described in DE-A-19650790.

In a presentation to the Macromolecular Colloquium Professor Dr. Ritter, incumbent of the Chair in Chemistry at the Heinrich Heine University, Düsseldorf, mentioned on Mar. 27, 2003 that the polymerization of methyl methacrylate in the presence of cyclodextrin may be accompanied by increased formation of fractions of isotactic regions.

Synthetic polymers have diverse uses. Of particular importance is their use as binders in coating compositions, e.g., protective coatings or decorative coatings, or in adhesives, or as binders for consolidating fiber webs. For utilities of this kind the desire is in particular for binders having good elasticity.

It is an object of the present invention to provide polymers having improved elasticity.

We have found that this object is achieved by the process defined at the outset and by the polymers obtainable by said process, and by their use.

The polymers prepared by the process of the invention have isotactic or syndiotactic regions (ordered regions for short). Unordered regions are atactic.

The tacticity describes the stereoisomerism of polymers wherein the copolymerized monomers possess asymmetric centers which may in sequence have a strictly consistent configuration (isotactic: R,R,R . . . or S,S,S . . . configuration) or in sequence a strictly alternating configuration (syndiotactic: R,S,R,S . . . ).

The configuration may alternatively switch arbitrarily between R and S (unordered regions).

The isotactic or syndiotactic regions are each composed of only one kind of monomer (homopolymer regions) or of two monomers which polymerize in strict alternation, e.g., maleic acid and diisobutene.

The monomers to be used for the ordered regions must, accordingly, be prochiral; that is, following their polymerization they form asymmetric centers in the resultant polymer.

In accordance with the invention the polymerization takes place in the presence of an optically active compound which forms a complex with the monomers to be polymerized.

In the form in which it is used this optically active compound consists to the extent of more than 50% by weight of only one of the possible enantiomers of this compound.

Preferably it consists to the extent of more than 70% by weight of only one of the enantiomers.

With particular preference the optically active compound is composed 100% by weight of only one enantiomer; in other words, it comprises exclusively a single one of the possible stereoisomeric forms (image or mirror image). At the same time, as a complexing agent, this compound must be capable of forming a complex with the monomer to be polymerized.

Preferably, within the complex, the monomer to be polymerized is spatially surrounded by the complexing agent.

Corresponding optically active compounds which are suitable as complexing agents are, for example, cyclodextrins (see also W. Saenger, Angew. Chemie Int. Ed. Engl. 1980, 19, 344) or noncyclic polysaccharides, especially starch degradation products. Suitable cyclodextrins include the cyclodextrins described in the literature reference given above. They are obtained, for example, by enzymatic degradation of starch as are composed of from 6 to 9 D-glucose units linked to one another by an α-1,4-glycosidic bond. α-Cyclodextrin is composed of 6 glucose molecules. Also suitable are compounds which comprise cyclodextrin structures. By compounds which comprise cyclodextrin structures are meant reaction products of cyclodextrins with reactive compounds, e.g., reaction products of cyclodextrins with alkylene oxides such as ethylene oxide, propylene oxide, butylene oxide or styrene oxide, reaction products of cyclodextrins with alkylating agents, such as C₁ to C₂₂ alkyl halides, e.g., methyl chloride, ethyl chloride, butyl chloride, ethyl bromide, butyl bromide, benzyl chloride, lauryl chloride, stearyl chloride or behenyl chloride, and dimethyl sulfate. Cyclodextrin can also be modified further by reaction with chloroacetic acid. Cyclodextrin derivatives which comprise cyclodextrin structures are also obtainable by enzymatic linkage with maltose oligomers. Examples of reaction products of the type indicated above include dimethyl-β-cyclodextrin, hydroxypropyl-β-cyclodextrin, and sulfonatopropyl-hydroxypropyl-β-cyclodextrin. Of the compounds of group (a) it is preferred to use α-cyclodextrin, β-cyclodextrin, γ-cyclodextrin and/or 2,6-dimethyl-β-cyclodextrin.

The cyclodextrins are normally present entirely in one of the possible enantiomeric forms.

The non cyclic polysaccharides include both unmodified polysaccharides and modified polysaccharides, e.g., polysaccharides which have been fully or partly derivatized on the OH groups. Polysaccharides of the invention are soluble in water or at least swellable in water. The saccharide is preferably a water-soluble or water-swellable starch or a chemically modified starch. The water-soluble or water-swellable starches comprise, for example, native starches which have been made swellable or soluble in water by boiling with water, or starch degradation products obtained from the native starches by hydrolysis, in particular by acid-catalyzed hydrolysis, enzyme-catalyzed hydrolysis or oxidation. Degradation products of this kind are also referred to as dextrins, roast (or torrefaction) dextrins or saccharified starches. Their preparation from native starches is known to the skilled worker and is described for example in G. Tegge, Stärke und Stärkederivate [Starch and Starch Derivatives], EAS Verlag, Hamburg 1984, p. 173ff and p. 220ff, and also in EP-A 0441 197. Native starches which can be used are virtually all starches of plant origin, examples being starches obtained from corn, wheat, potato, tapioca, rice, sago, and common sorghum.

Preference is also given to chemically modified starches. By chemically modified starches are meant those starches or starch degradation products in which the OH groups are at least partly in derivatized form, e.g., in etherified or esterified form. Chemical modification can be performed both on the native starches and on the degradation products. It is also possible to convert chemically modified starches subsequently into their chemical modified degradation products.

The esterification of starch can take place with both organic and inorganic acids, their anhydrides or their chlorides. Common esterified starches are phosphated and/or acetylated starches and starch degradation products. Etherification of the OH groups can take place, for example, using organic halogen compounds, epoxides or sulfates in aqueous alkaline solution. Examples of suitable ethers are alkyl ethers, hydroxyalkyl ethers, carboxyalkyl ethers, allyl ethers, and cationically modified ethers, e.g. (trisalkylammonium)alkyl ethers and (trisalkylammonium)hydroxyalkyl ethers. Depending on the nature of the chemical modification the starches or starch degradation products may be neutral, cationic, anionic or amphiphilic. The preparation of modified starches and starch degradation products is known to the skilled worker (see. Ullmann's Encyclopedia of Industrial Chemistry, 5th ed., Vol. 25, p. 12-21 and literature cited therein).

One preferred embodiment of the present invention uses water-soluble starch degradation products and their chemically modified derivatives obtainable by hydrolysis, oxidation of enzymatic degradation of native starches or chemically modified starch derivatives. Starch degradation products of this kind are also referred to as saccharified starches (see G. Tegge, p. 220ff). Saccharified starches and their derivatives are available commercially as such (e.g., C*pur products 01909, 01908, 01910, 01912, 01915, 01921, 01924, 01932 or 01934 from Cerestar Deutschland GmbH, Krefeld) or can be prepared by degrading standard commercial starches using known methods, for example, by oxidative hydrolysis with peroxides or enzymatic hydrolysis, starting from the starches or chemically modified starches. Particular preference is given to starch degradation products which have not undergone chemical modification.

One particularly preferred embodiment of the present invention uses starch degradation products, with or without chemical modification, which have a weight-average molecular weight, M_{w} in the range from 500 to 500000 daltons, in particular from 1000 to 30000 daltons and very preferably from 3000 to 10000 daltons. Starches of this kind are fully soluble in water at 25° C. and 1 bar, the solubility limit generally being above 50% by weight, which is particularly favorable for the preparation of the aqueous polymer dispersions of the invention. Figures for the molecular weight of the saccharified starches for use in accordance with the invention are based on determinations made by means of gel permeation chromatography under the following conditions:

Columns: 3 steel columns, 7.5×600 mm, packed with TSK-Gel G 2000 PW and G 4000 PW. Pore size 5 mm.

Eluent: Distilled water

Temp.: RT (room temperature)

Detection: Differential refractometer (e.g. ERC 7511)

Flow rate: 0.8 ml/min. pump: (e.g. ERC 64.00)

Injector: 20 ml valve: (e.g. VICI 6-way valve)

Evaluation: Bruker Chromstar GPC software

Calibration: In the low molecular mass range, using glucose, raffinose, maltose, and maltopentose. For the higher molecular mass range, using pullulan standards with a polydispersity <1.2.

The non cyclic polysaccharides are generally present entirely in only one of the possible enantiomeric forms.

The monomers to be polymerized suitably include any desired monomers.

Preference is given to free-radically polymerizable monomers, particularly those having a polymerizable double bond.

At least 10%, preferably at least 50%, or preferably at least 80%, and very preferably 100% by weight of the total monomers used to prepare the polymer ought to be prochiral.

The monomers, accordingly, cannot exclusively comprise, say, ethylene, which is not prochiral.

Preferably at least some of the monomers used are monomers having a water solubility of less than 20 g of monomer per liter of water (20° C., 1 bar).

Preferably at least 50% by weight, in particular at least 80% by weight, and very preferably at least 95% by weight of the monomers are monomers with the above limited water solubility.

These monomers (monomers a for short) include ethylenically unsaturated monomers which are insoluble in water or have a solubility in water at 20° C. of not more than 20 g/l. Examples of such compounds are C₂ to C₄₀ alkyl esters of acrylic acid or C, to C₄₀ alkyl ester of methacrylic acid, such as methyl methacrylate, ethyl acrylate, ethyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert.-butyl acrylate, pentyl acrylate, pentyl methacrylate, n-hexyl acrylate, n-hexyl methacrylate, n-heptyl acrylate, n-heptyl methacrylate, n-octyl acrylate, n-octyl methacrylate, 2-ethylhexyl acrylate, 2-ethylhexyl methacrylate, decyl acrylate, decyl methacrylate, lauryl acrylate, lauryl methacrylate, palmityl acrylate, palmityl methacrylate, octadecyl acrylate, octadecyl methacrylate, phenoxyethyl acrylate, phenoxyethyl methacrylate, and phenylacrylate and phenyl methacrylate.

Further monomers of group (a) are α-olefins having 2 to 30 carbon atoms and also polyisobutylenes, having 3 to 50, preferably 15 to 35, isobutene units. Examples of α-olefins are ethylene, propylene, n-butene, isobutene, pent-1-ene, cyclopentene, hex-1-ene, cyclohexene, oct-1-ene, diisobutylene (2,4,4-trimethyl-1-pentene alone or in a mixture with 2,4,4-trimethyl-2-pentene), dec-1-ene, dodec-1-ene, octadec-1-ene, C₁₂/C₁₄ olefins, C₂₀/C₂₄ olefins, styrene, α-methylstyrene, polypropylenes having a terminal vinyl or vinyliden group and from 3 to 100 propylene units, oligohexene or oligooctadecene.

A further class of monomers of group (a) are N-alkyl-substituted acrylamides and methacrylamides, such as N-tert-butylacrylamide, N-hexylmethacrylamide, N-octylacrylamide, N-nonylmethacrylamide, N-dodecylmethacrylamide, N-hexadecylmethacrylamide, N-methacrylamidocaproic acid, N-methacrylamidoundecanoic acid, N,N-dibutylacrylamide, N-hydroxyethylacrylamide and N-hydroxyethylmethacrylamide.

Other group (a) monomers are vinyl alkyl ethers having 1 to 40 carbon atoms in the alkyl radical, examples being methyl vinyl ether, ethyl vinyl ether, n-propyl vinyl ether, isopropyl vinyl ether, n-butyl vinyl ether, isobutyl vinyl ether, 2-ethylhexyl vinyl ether, decyl vinyl ether, dodecyl vinyl ether, octadecyl vinyl ether, 2-(diethylamino)ethyl vinyl ether, 2-(di-n-butyl-amino)ethyl vinyl ether, methyldiglycol vinyl ether and the corresponding allyl ethers such as allyl methyl ether, allyl ethyl ether, allyl-n-propyl ether, allyl-isobutyl ether, and allyl-2-ethylhexyl ether. Moreover, suitability as compounds of group (b) is possessed by the esters of maleic acid and fumaric acid which are insoluble in water or have a solubility of in water of up to 20 g/l at most and which derive from monohydric alcohols having 1 to 22 carbon atoms, examples for these esters being mono-n-butyl maleate, dibutyl maleate, monodecyl maleate, didodecyl maleate, monooctadecyl maleate, and dioctadecyl maleate. Also suitable are vinyl esters of saturated C₃ to C₄₀ carboxylic acids such as vinyl propionate, vinyl butyrate, vinyl valerate, vinyl 2-ethylhexanoate, vinyl decanoate, vinyl palmitate, vinyl stearate, and vinyl laurate. Other group (b) monomers are methacrylonitrile, vinyl chloride, vinylidene chloride, isoprene, and butadiene.

The abovementioned monomers of group (a) can be used alone or in a mixture. Compounds of preferred suitability as monomers (a) are C₂ to C₃₀ alkyl ester of acrylic acid, C₁ to C₃₀ alkyl ester of methacrylic acid, C₂ to C₃₀ a-olefins, C₁ to C₂₀ alkyl vinyl ethers, styrene, butadiene, isoprene or mixtures thereof. Particularly preferred monomers (a) are methyl methacrylate, butyl acrylate, lauryl acrylate, stearyl acrylate, isobutene, hex-1-ene, diisobutene, dodec-1-ene, octadec-1-ene, polyisobutene having 15 to 35 isobutene units, styrene, methyl vinyl ether, ethyl vinyl ether, octadecyl vinyl ether or mixtures thereof.

Further suitable monomers (a) include monomers having a crosslinking action, which contain at least two ethylenically unsaturated, nonconjugated double bonds in the molecule. Compounds of this kind are generally used in a relatively small amount together with water-soluble monomers, in order to prepare water-swellable polymers. Such copolymers are important, for example, as water-absorbing polymers. The problem here is that for this purpose it is generally been necessary to use water-soluble crosslinkers in order to prepare uniform polymers. In accordance with the process of the invention it is possible to copolymerize even very sparingly water-soluble or water-insoluble crosslinkers homogeneously into the resultant crosslinked copolymer with a predominant fraction of water-soluble monomers. Examples of suitable crosslinkers of component (b) are divinylbenzene, diallylphthalate, allyl vinyl ether and/or diallylfumarate. The water-insoluble crosslinkers can be polymerized alone, to form homopolymers, or together with water-soluble monomers, to form copolymers. If crosslinkers are used in the copolymerization of water-soluble monomers the amount of crosslinker, based on the amount of monomers used in the polymerization, is from 0.05 to 10%, preferably from 0.1 to 2% by weight.

Complexes of the monomers in the optically active complexing agent can be prepared by known methods. For example, a cyclodextrin and/or a compound which comprises cyclodextrin structures, and at least one monomer (a), can be dissolved together in a solvent and the solution can be heated where appropriate. Removal of the solvent leaves a crystallining complex. One molecule of the complexing agent is able to comprise in bound form up to two molecules of the monomers (a) in complex form. These complexes are referred to in the literature as host/guest complexes. The cyclodextrins or compounds which comprise cyclodextrin structures comprise the water-insoluble monomer in their cavities.

The complexes can also be prepared, for example, by introducing the individual components into a solvent which dissolves, for example, only the cyclodextrins and/or compounds which comprise cyclodextrin structures, but not the water-insoluble monomers. The process of host/guest complex formation can be accelerated by heating, stirring, ultrasound treatment or other mechanical or thermal measures. It is also possible to form the complexes in a solvent which dissolves only the monomers (a) but not the cyclodexrins. The complexes can also be formed in the absence of solvent and diluent, if the cyclodextrins and/or compounds which comprise cyclodextrin structures are present in sufficiently fine distribution and are contacted with the monomers (a). A further possibility is to evaporate the monomers (a) and cause them to act on the cyclodextrins from the gas phase. A procedure of this kind is particularly preferred, for example, when preparing complexes of cyclodextrins and low-boiling monomers (b). For example, ethylene, propylene or isobutene can be passed over finely divided cyclodextrins. The formation of the complexes can be performed under atmospheric pressure or under subatmospheric or superatmospheric pressure. The molar ratio of the components (a):(b) is from 1:2 to 10:1 and is preferably situated within the range from 1:1 to 5:1.

The monomers (a) can be free-radically polymerized alone or in a mixture with one another. Another possibility is to copolymerize monomers (a) with water-soluble monomers. Suitable water-soluble monomers, which will be referred to below as monomers of group (b), are, for example, monoethylenically unsaturated C₃ to C₅ carboxylic acids, their amides and esters with amino alcohols of the formula 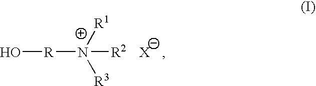
where R=C₂ to C₅ alkylene, R¹, R², and R³=H, CH₃, C₂H₅, C₃H₇ and X^{⊖} is an anion. Suitability is likewise possessed by amides derived from amines of the formula

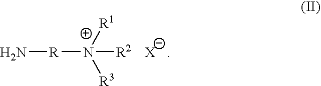

The substituents in formula II and X^{⊖} have the same definition as in formula I.

These compounds comprise, for example, acrylic acid, methacrylic acid, crotonic acid, itaconic acid, maleic acid, fumaric acid, acrylamide, methacrylamide, crotonamide, dimethylaminoethyl acrylate, diethylaminoethyl acrylate, dimethylaminoneopentyl acrylate and dimethylaminoethyl methacrylate, dimethylaminopropyl acrylate, dimethylaminoneopentyl acrylate and dimethylaminoneopentyl methacrylate. The basic acrylates and methacrylates and/or basic amides deriving from the compounds of the formula II are used in the form of the salts with strong mineral acids, sulfonic acids or carboxylic acids or in quaternized form. The anion X^{⊖} for the compounds of the formula I is the acid residue of the mineral acids or of the carboxylic acids or methosulfate, ethosulfate or halide from a quaternizing agent.

Further water-soluble monomers of group (b) are N-vinylpyrrolidone, N-vinylformamide, acrylamidopropansulfonic acid, vinylphosphonic acid and/or alkali metal salts and/or ammonium salts of vinylsulfonic acid. For the polymerization the other acids can likewise be used either in non-neutralized form or in partially neutralized form or with up to 100% neutralization. Suitable water-soluble monomers of group (c) also include diallylammonium compounds, such as dimethyldiallylammonium chloride, diethyldiallylammonium chloride or diallylpiperidinium bromide, N-vinylimidazolium compounds, such as salts or quaternarization products of N-vinylimidazole and 1-vinyl-2-methylimidazole, and N-vinylimidazoline, such as N-vinylimidazoline, 1-vinyl-2-methylimidazoline, 1-vinyl-2-ethylimidazoline or 1-vinyl-2-n-propylimidazoline, which are likewise used in quaternarized form or as a salt in the polymerization.

Preferred group (b) monomers are monoethylenically unsaturated C₃ to C₅ carboxylic acids, vinylsulfonic acid, acrylamidomethylpropanesulfonic acid, vinylphosphonic acid, N-vinylformamide, dimethylaminoethyl (meth)acrylates, alkali metal salts or ammonium salts of the abovementioned monomers comprising acid groups, or mixtures of the monomers with one another. Of particular economic importance is the use of acrylic acid or mixtures of acrylic acid and maleic acid or their alkali metal salts in the preparation of hydrophobically modified water-soluble copolymers.

The polymerization of the water-insoluble monomers and, where appropriate, of the water-soluble monomers takes places preferably in the manner of a solution or precipitation polymerization, preferably in water, water-miscible liquids or mixtures thereof, more preferably in water or in aqueous medium. In the present context an aqueous medium means mixtures of water and water-miscible organic liquids. Examples of water-miscible organic liquids are glycols such as ethylene glycol, propylene glycol, block copolymers of ethylene oxide and propylene oxide, alkoxylated C₁ to C₂₀ alcohols, acetates of glycols and polyglycols, alcohols such as methanol, ethanol isopropanol, and butanol, acetone, tetrahydrofuran, dimethylformamide, N-methylpyrrolidone or else mixtures of said solvents. Where the polymerization takes place in mixtures of water and water-miscible solvents the fraction of water-miscible solvents in the mixture is up to 45% by weight. With preference, however, the polymerization is conducted in water.

The polymerization of the monomers takes place in accordance with the invention at temperatures below 20° C., more preferably below 15° C., and very preferably below 10° C., and in particular below 0° C. At temperatures below 10° C. or below 0° C. it is possible where appropriate to use auxiliaries which lower the freezing point of the solvent or solvent mixtures used.

The polymerization can be conducted batchwise or continuously. Preferably at least a fraction of the monomers, initiators, and, where used, regulators is metered into the reaction vessel at a uniform rate during the polymerization. In the case of relatively small batches, however, it is also possible to charge the monomers and the polymerization initiator to the reactor and polymerize them, in which case it may be necessary to ensure sufficiently rapid removal of the heat of polymerization by cooling.

Suitable polymerization initiators are the compounds commonly used for free-radical polymerizations, which yield free radicals under the polymerization conditions, examples being peroxides, hydroperoxides, peroxodisulfates, percarbonates, peroxy esters, hydrogen peroxide, and azo compounds. Examples of initiators are hydrogen peroxide, dibenzoyl peroxide, dicyclohexyl peroxide dicarbonate, dilauryl peroxide, methyl ethyl ketone peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, and lithium, sodium, potassium, and ammonium peroxodisulfates, azoisobutyronitrile, 2,2′-azobis(2-amidinopropane) dihydrochloride, 2-(carbamoylazo)-isobutyronitrile, and 4,4′-azobis(4-cyanovaleric acid). The initiators are used usually in amounts of up to 15%, preferably from 0.02 to 10%, by weight, based on the monomers to be polymerized.

The initiators can be used alone or in a mixture with one another. Also suitable is the use of the known redox catalysts in which the molar amount of the reducing component used is substoichiometric. Examples of known redox catalysts include salts of transition metals, such as iron(II) sulfate, cobalt(II) chloride, nickel(II) sulfate, copper(I) chloride, manganese(II) acetate, and vanadium(III) acetate. Further suitable redox catalysts include sulfur compounds which have a reducing action, such as sulfites, bisulfites, thiosulfates, dithionites and tetrathionates of alkali metals and ammonium compounds, or phosphorus compounds which have a reducing action and in which phosphorus has an oxidation number of from 1 to 4, such as sodium hypophosphite, phosphorous acid, and phosphites, for example.

In order to control the molecular weight of the polymers it is possible where appropriate to conduct the polymerization in the presence of regulators. Examples of suitable regulators include aldehydes such as formaldehyde, acetaldehyde, propionaldehyde, n-butyraldehyde and isobutyraldehyde, formic acid, ammonium formiate, hydroxylammonium sulfate, and hydroxylammonium phosphate. It is also possible to use regulators comprising sulfur in organically bonded form, such as organic compounds containing SH groups, such as thioglycolacetic acid, mercaptopropionic acid, mercaptoethanol, mercaptopropanol, mercaptobutanols, mercaptohexanol, dodecyl mercaptan, and tert-dodecyl mercaptan. Further regulators which can be used include salts of hydrazine, such as hydrazinium sulfate. The amounts of regulator, based on the monomers to be polymerized, are from 0 to 20%, preferably from 0.5 to 15% by weight.

Where, for the polymerization, the monomers (b) are introduced into the reactor not in the form of complexes of complexing agent and group (b) monomers, the monomers (b) can be metered into an aqueous solution of the complexing agent and subjected to polymerization in the presence of polymerization initiators and, where used, regulators. Within the reaction medium, complexes are formed from the monomers (b) and the complexing agents present therein.

Following the polymerization the polymers are usually separate from the complexing agents. For example, copolymers of acrylic acid containing more than 20% by weight of water-insoluble monoethylenically unsaturated compounds such as stearyl acrylate or polyisobutene are precipitated from the aqueous reaction solution. Where the polymers following preparation are still in the form of inclusion compounds, they can be liberated from the inclusion compounds and isolated by means, for example, of adding wetting agents, for example, such as ethoxylated long-chain alcohols to the reaction mixture.

According to the process of the invention it is possible to obtain both low and high molecular mass polymers.

The process is suitable for preparing polymers having a weight-average molecular weight M_{w} of from 5000 to 500000 g/mol. The process is also suitable for preparing polymers having a molecular weight M_{w} of more than 1 million g/mol, and in particular more than 1.5 million.

M_{w} is generally less than 10 million and is determined by gel permeation chromatography.

The polymer comprises ordered regions (isotactic and/or syndiotactic fractions) alongside unordered regions (atactic regions). The regions differ in their phase transition temperatures. In differential thermal analysis or in dielectric spectroscopy, therefore, at least two phase transition temperatures are found. These can be, for example, two glass transition temperatures (glass state/liquid transition) or at least one glass transition temperature and one melting point (crystalline/liquid transition).

The weight fraction of the ordered regions in the polymer as a whole is preferably at least 0.1% by weight, in particular at least 0.5% by weight, more preferably at least 2% by weight or 5% by weight or at least 10% by weight.

Besides the ordered regions the polymer comprises other, i.e., unordered regions. The fraction of the ordered regions is generally less than 90% by weight, in particular less than 75% by weight, and more preferably more than 70% by weight.

In one particularly preferred embodiment the fraction of the ordered regions is from 20 to 70% by weight, in particular from 30 to 70% by weight.

The tacticity can be determined by means of ¹H NMR spectroscopy (integral of the methylene signals).

It is assumed that the very existence of ordered regions alongside unordered regions produces particular elasticity in the resultant polymers.

On account of their elasticity the polymers are suitable as coating compositions. They are particularly suitable for use as paints or coatings on leather, with polymers particularly suitable for this utility having an M_{w} of more than 1 million g/mol.

The coating compositions, or paints, leather coatings, can consist solely of the polymer as binder; naturally, however, they may also comprise additives such as dyes, pigments, leveling agents, thickeners, etc.

The polymers are also suitable for use as detergent additives, as scale inhibitors or as dispersants. For these applications the polymer preferably has a weight-average molecular weight of from 5000 to 500000. Scale inhibitors are additives which reduce the formation of deposits in hot water, such as in evaporators, for example.

### EXAMPLES

Low-temperature polymerization of cyclodextrin-complexed vinyl monomers in aqueous phase

1 Monomers

FIG. 1 depicts the monomers used. The monomers were purified by vacuum distillation prior to the polymerization experiments. 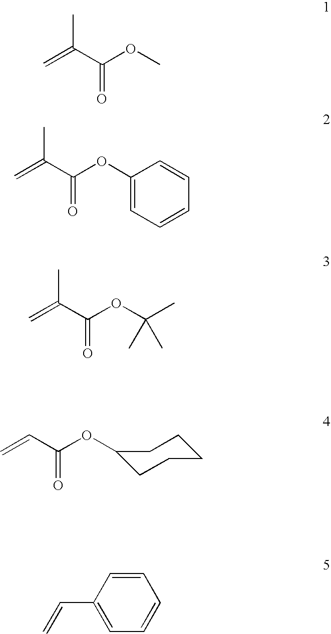
FIG. 1: Methyl methacrylate (1), phenyl methacrylate (2), t-butyl methacrylate (3), cyclohexyl acrylate (4), styrene (5).
2 Polymerization Experiments
2.1 Homopolymerization

The technical-grade cyclodextrin (CD) used comes from Wacker Chemie GmbH (Cavasol W7M Pharma) and has a degree of methylation of 1.8 per glucose unit.

The reaction medium used was demineralized water.

¹J. A. Shetter, Polymer Letters, 1963,1,209-213.

²C. Pilcher, W. T. Ford, Journal of Polymer Science: Part A: Polym. Chem., 2001, 39, 519.

³R. J. Andrews, E. A. Grulke, in Polymer Handbook, 4th ed., J. Brandrup, E. H. Immergut, E. A. Grulke, Eds.; Wiley: New York, 1999; p V1/204.

⁴E. H. Immergut, J. Brandrup, Polymer Handbook, 1989, John Wiley & Sons, New York.

2.1.1 Homopolymerization of Methyl Methacrylate (1) 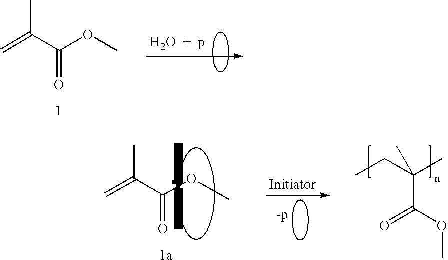
FIG. 2: Homopolymerization of methyl methacrylate in the presence of CD.

6.66 g of CD (5 mmol) are weighed out into a 50 ml single-necked flask with septum and are dissolved in 10 ml of distilled water. Following the addition of 0.711 g (5 mmol) of methyl methacrylate the reaction solution is flushed with nitrogen for 30 minutes while stirring. Formation of the complex is evident from the clarification of the solution, which to start with is turbid as a result of dispersed monomer droplets. Following the addition of 1 g of NaCl the reaction solution is cooled in an ice bath to the reaction temperature. Subsequently the polymerization is initiated by adding 10 mol % Na₂S₂O₅ and K₂S₂O₈. After a reaction time of 2 h the precipitated polymer is filtered off, washed with water and ethanol and dried under reduced pressure. Table 1 lists the reaction temperatures, T, of the polymerizations carried out and also the tacticity of the polymers prepared and their T_{g} values. The tacticity of the polymer samples was ascertained from the integrals of the methylene signals in the ¹H NMR spectrum (Bruker Avance DRX500 (500 MHz)).

TABLE 1
Polymerization of methyl methacrylate (1).

| Reaction temperature | | Tacticity/% | | | |
|---|---|---|---|---|---|
| T/° C. | | isotactic | atactic | syndiotactic | Tg/° C. |
| −7° | C. | 5.9 | 36.2 | 57.9 | 98 |
| 0° | C. | 5.5 | 38.0 | 56.5 | 116 |
| RT | | 5.6 | 38.5 | 55.9 | 120 |
| 0° | C. a) | 3.7 | 33.3 | 63.0 | 121 |

a) Polymerization of methyl methacrylate in H₂O withot CD under identical experimental conditions.

The literature values of the glass transition temperature of polymethyl methacrylate amount to 115° C. for a predominantly syndiotactic sample and 45° C. for a predominantly isotactic sample.⁵ According to results to date, a lowering of the polymerization temperature T leads to an increase in the isotactic fraction, as suggested both by the evaluation of the ¹H NMR spectra and by the lowering of the T_{g} value.
⁵ J. A. Shetter, Polymer Letters, 1963, 1, 209-213.

2.1.2 Homopolymerization of Phenol Methacrylate (2) 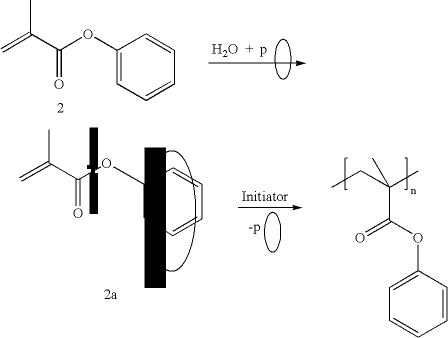
FIG. 3: Homopolymerization of phenyl methacrylate in the presence of CD.
Experiments A

Phenyl methacrylate is homopolymerized in water or in an ethanol/water solution in the form of a cyclodextrin complex (monomer:CD (1:1.25)) under different reaction conditions (temperature, reacton time) using the redox initiator system K₂S₂O₈/Na₂S₂O₅ under an N₂ atmosphere. The thermal properties of the resulting polymers are investigated by means of DSC (T_{g}, Tₘ). The reaction conditions of the experiments carried out and also the corresponding T_{g} values are listed in Table 1.

TABLE 2
Polymerization of phenyl methacrylate (2).

| T/° C. | t/h | Int./mol % | m(NaCl)/g | Solv./ml | Tg/° C. |
|---|---|---|---|---|---|
| rt | 3 | 5 | — | 10 ml H₂O | 103.83 |
| 0 | 3 | 5 | — | 10 ml H₂O | 117.20 |
| −5 | 3 | 5 | — | 8 ml H₂O | 121.39 |
| | | | | 2 ml EtOH | |
| −10 | 3 | 5 | — | 2 ml H₂O | 124.43 |
| | | | | 8 ml EtOH | |
| rt | 1 | 2.5 | 1 | 10 ml H₂O | 126.27 |
| 0 | 1 | 2.5 | 1 | 10 ml H₂O | 126.21 |
| −5 | 1 | 2.5 | 1 | 10 ml H₂O | 122.84 |

Experiments B

Phenyl methacrylate (5 mmol, 0.8 ml) is homopolymerized in the form of a cyclodextrin complex (monomer:CD (1:1.25)) in 10 ml of water at 60° C., 25° C., 0° C., −10° C. and −20° C. with 5 mol % of a redox initiator system K₂S₂O₈/Na₂S₂O₅ under an N₂ atmosphere. The reaction time for all batches is 2 h. In the case of the reaction temperatures 25° C., 0° C. and −10° C., 5 g of MgCl₂.6H₂O are added to the aqueous complex solution. At the reaction temperature of −20° C., 5 g of CaCl₂.6H₂O are added to the aqueous complex solution in order to prevent the formation of ice crystals. The polymerization is initiated by addition of the redox initiator system K₂S₂O₈/Na₂S₂O₅ and is stopped after 2 h by a dilution of the solution with a 1:1 methanol/H₂O solution and immediate removal of the precipitated polymer by filtration. The polymer is washed with methanol and H₂O. Subsequently the polymer is dissolved in toluene and the filtered toluene solution is added to vigorously stirred methanol in order to reprecipitate the polymer. The reaction conditions of the experiments carried out and also the corresponding T_{g} values are listed in Table 3.

TABLE 3
Polymerization of phenyl methacrylate (2).

| T/° C. | t/h | Int./mol % | m(salt)/g | Tg(average)/° C. | Tg(onset)/° C. |
|---|---|---|---|---|---|
| 60 | 2 | 5 | — | 126.89 | 119.91 |
| 25 | 2 | 5 | 5 g MgCl₂ | 128.21 | 122.21 |
| 0 | 2 | 5 | 5 g MgCl₂ | 128.01 | 122.95 |
| −10 | 2 | 5 | 5 g MgCl₂ | 128.76 | 122.34 |

Values found in the literature for the glass transition temperature of polyphenyl methacrylate are between 122-128° C., as determined by DSC measurements using the average-value method⁶, or values as low as 110° C. and as high as 134° C., as determined by other methods⁷.
⁶SC. Pilcher, W. T. Ford, Journal of Polymer Science: Part A: Polym. Chem., 2001, 39, 519.

⁷ R. J. Andrews, E. A. Grulke, in Polymer Handbook, 4th ed., J. Brandrup, E. H. Immergut, E. A. Grulke, Eds.; Wiley: New York, 1999; p V1/204.

2.1.3 Homopolymerization of t-butyl methacrylate (5). 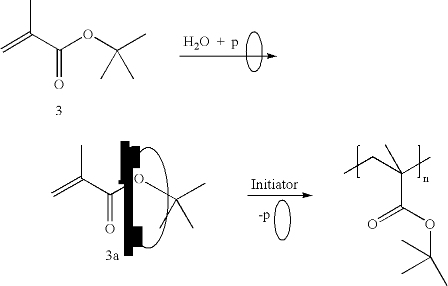
FIG. 4: Homopolymerization of t-butyl methacrylate in the presence of CD.

t-Butyl methacrylate (5 mmol, 0.81 ml) is homopolymerized in the form of a cyclodextrin complex (monomer:CD (1:1.25)) in 10 ml of water at 60° C., 25° C., 0° C., −10° C. and −20° C. with 5 mol % of a redox initiator system K₂S₂O₈/Na₂S₂O₅ under an N₂ atmosphere. The reaction time for all batches is 2 h. At reaction temperatures of 25° C., 0° C., −10° C. and −20° C., 5 g of CaCl₂.6H₂O are added to the aqueous complex solution in order to prevent the formation of ice crystals. The polymerization is initiated by addition of the redox initiator system and is terminated after 2 h by a dilution of the solution with a 1:1 methanol/H₂O solution and immediate removal of the precipitated polymer by filtration.

The reaction conditions of the experiments carried out and also the corresponding T_{g} values are listed in Table 4.

TABLE 4
Polymerization of poly(t-butyl methacrylate).

| | | Int./ | | Tg(average)/ | | Tg(onset)/ | |
|---|---|---|---|---|---|---|---|
| T/° C. | t/h | mol % | m(CaCl₂*6H₂O) | ° C. | | ° C. | |
| 60 | 2 | 5 | — | 59.94 | | 44.07 | |
| 25 | 2 | 5 | 5 | 56.62 | a) | 43.20 | a) |
| 0 | 2 | 5 | 5 | 51.85 | | 41.37 | |
| −10 | 2 | 5 | 5 | 76.83 | | 57.44 | |

a) T_{g} value from 3rd heating curve

The literature values of atactic, syndiotactic and isotactic poly(t-butyl methacrylate) are set out in Table 5.

TABLE 5
Literature values for the glass transition temperature,
T_{g}, of poly(t-butyl methacrylate).

| Poly(t-butyl methacrylate) | Tg/° C. |
|---|---|
| Atactic | 117.85 |
| Syndiotactic | 113.85 |
| Isotactic | 6.85 |

2.1.4 Homopolymerization of Cyclohexyl Acrylate (4) 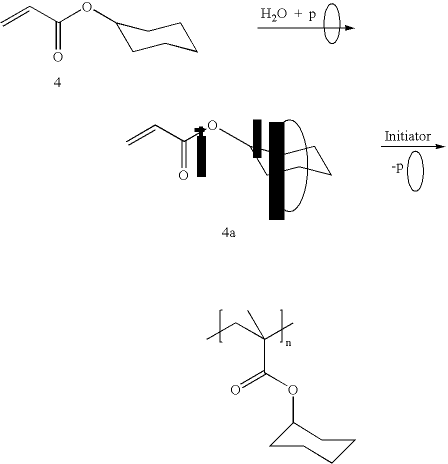
FIG. 5: Homopolymerization of cyclohexyl acrylate in the presence of CD.
Experiments A

8.2 g (6.25 mmol) of CD are weighed out into a 100 ml single-necked flask with septum and are dissolved in 10 ml of distilled water. Subsequently 0.711 g (5 mmol) of cyclohexyl acrylate is added to the solution. The formation of a complex is from the clearing of the solution, which to start with is turbid as a result of dispersed monomer droplets. Following the addition of 1 g of NaCl the solution is flushed with nitrogen while stirring and is cooled in an ice bath to the reaction temperature. Thereafter the polymerization is initiated by addition of 2.5 mol % of K₂S₂O₈ and Na₂S₂O₅. After a reaction time of 1 h the precipitated polymer is filtered off and washed with water and methanol. The reaction conditions of the experiments carried out and also the corresponding T_{g} values are listed in Table 6.

TABLE 6
Polymerization of cylohexyl acrylate (3).

| | T/° C. | t/h | Int./mol % | m(NaCl)/g | Tg |
|---|---|---|---|---|---|
| CHA1 | rt | 1 | 2.5 | 1 | 34.97 |
| CHA2 | −5 | 2 | 2.5 | 1 | 29.42 |

Experiments B

Cyclohexyl acrylate (5 mmol, 0.9 ml) is homopolymerized in the form of a cyclodextrin complex (monomer:CD (1:1.25)) in 10 ml of water at 60° C., 25° C., 0° C. and −10° C. with 5 mol % of the redox initiator system K₂S₂O₈/Na₂S₂O₅ under an N₂ atmosphere. The reaction time for all batches is 2 h. At reaction temperatures of 25° C., 0° C. and −10° C., 5 mg of MgCl₂.6H₂O are added to the aqueous complex solution in order to prevent the formation of ice crystals. The polymerization is initiated by addition of the redox initiator system K₂S₂O₈/Na₂S₂O₅ and is terminated after 2 h by dilution with the reaction solution with a 1:1 methanol/H₂O solution, addition of 4-tert-butylpyrocatechol and immediate removal of the precipitated polymer by filtration.

The reaction conditions of the experiments carried out and also the corresponding T_{g} values are listed in Table 7.

TABLE 7
Polymerization of cyclohexyl acrylate (4).

| | | Int./ | | Tg(average)/ | Tg(onset)/ |
|---|---|---|---|---|---|
| T/° C. | t/h | mol % | m(MgCl₂*6 H₂O) | ° C. | ° C. |
| 60 | 2 | 5 | — | 30.04 | 20.81 |
| 25 | 2 | 5 | 5 | 23.99 | 8.15 |
| 0 | 2 | 5 | 5 | 32.02 | 25.38 |
| −10 | 2 | 5 | 5 | 23.93 | 17.07 |

The T_{g} value of poly(cyclohexyl acrylate) is affected by the tacticity of the polymer, as is apparent from Table 8. Conversely, investigating the T_{g} value promises to reveal information on the tacticity of the polymer.

Table 8: Literature values for the glass transition temperature, T_{g}, of poly(cyclohexyl acrylate).⁸
⁸ E. H. Immergut, J. Brandrup, Polymer Handbook, 1989, John Wiley & Sons, New York.

| Poly(cyclohexyl acrylate) | Tg/° C. |
|---|---|
| Conventional | 18.85 |
| Syndiotactic | 15.85 |
| isotactic | 11.85 |

2.1.5 Homopolymerization of Styrene (5) 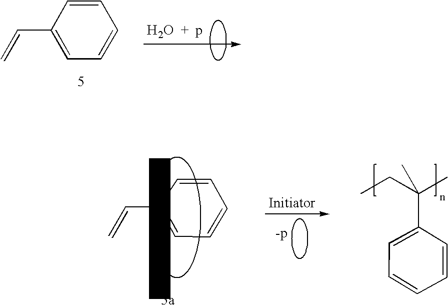
FIG. 5: Homopolymerization of styrene in the presence of CD.
Experiments A

Styrene is homopolymerized in water in the form of a cyclodextrin complex (monomer:CD (1:1.25)) under different reaction conditions (reaction temperature, reaction time and initiator quantity) with the redox initiator system K₂S₂O₈₁Na₂S₂O₅ under an N₂ atmosphere. The thermal properties of the resulting polymers are investigated by means of DSC (T_{g}, Tₘ). The reaction conditions of the experiments carried out and also the corresponding T_{g} values are listed in Table 1.

TABLE 9
Polymerization of styrene

| | T/° C. | t/h | Init./mol % | Tg/° C. |
|---|---|---|---|---|
| S1 | rt | 2 | 2.5 | 104.54 |
| S2 | 0 | 3 | 2.5 | 105.93 |
| S3 | −5 | 3 | 5 | 98.91 |
| HC1a | rt | 2 | 5 | 97.00 |

Experiments B

Styrene (5 mmol, 0.6 ml) is homopolymerized in the form of a cyclodextrin complex (monomer:CD (1:1.25)) in 10 ml of water at 60° C., 25° C., 0° C., −10° C. and −20° C. with 5 mol % of the redox initiator system K₂S₂O₈/Na₂S₂O₅ under an N₂ atmosphere. The reaction time for all batches is 2 h. At reaction temperatures of 25° C., 0° C. and −10° C., 5 g of MgCl₂.6H₂O are added to the aqueous complex solution in order to prevent the formation of ice crystals. The polymerization is initiated by addition of the redox initiator system and is terminated after 2 h by dilution of the reaction solution with a 1:1 methanol/H₂O solution, addition of 4-tert-butylpyrocatechol and immediate removal of the precipitated polymer by filtration. The polymer is washed with H₂O and methanol and then dissolved in THF and reprecipitated by addition of the polymer solution to vigorously stirred methanol.

The syndiotactic reference polymer provided by BASF possesses a T_{g} value of 97.18° C. and a melting peak at 270.51° C.

TABLE 10
Polymerization of styrene

| | | Int./ | | Tg(average)/ | Tg(onset)/ |
|---|---|---|---|---|---|
| T/° C. | t/h | mol % | m(MgCl₂*6 H₂O) | ° C. | ° C. |
| 60 | 2 | 5 | — | 94.39 | 88.74 |
| 25 | 2 | 5 | 5 | 103.01 | 99.46 |
| 0 | 2 | 5 | 5 | 106.84 | 102.50 |
| −5 | 2 | 5 | 5 | 94.81 | 88.16 |
| −10 | 2 | 5 | 5 | 91.78 | 65.06 |

In the literature it is stated both that for syndiotactic and isotactic polystyrene the glass transition temperature for the amorphous phase is 100° C.⁹, and that the glass transition Temperature of syndiotactic polystyrene has a value of 104° C.¹⁰. The melting point of syndiotactic polystryene, at 273° C., however, is much higher than the melting point of isotactic polystryene (176-224° C.).¹¹
⁹A. J. Pasztor, Jr., B. G. Landes, P. J. Karjala, Thermochim. Acta, 1991, 177, 187.

¹⁰M. Malanga, Adv. Mater., 2000, 12, 1869.

¹¹A. J. Pasztor, Jr., B. G. Landes, P. J. Karjala, Thermochim. Acta, 1991, 177, 187.

3 Differential Scanning Calorimetry (DSC)

The DSC spectra were recorded with a Mettler DSC 30 instrument using 5-10 mg of polymer.

The sample of polymethyl methacrylate was heated from −50° C. to 200° C. at 5° C. per minute. The sample is held at 200° C. for 10 minutes and then cooled to −40° C. (−10° C./min). Subsequently the sample is heated again to 200° C. (5° C./min).

The polymer samples of polyphenyl methacrylate, polycyclohexyl acrylate and styrene from Experiments A were heated to 200° C. at 10° C. per minute and then cooled to −50° C. (−5° C./min), a temperature which was held for 10 minutes. The sample is then heated again to 200° C. (5° C./min), thereafter cooled to −50° C. (−5° C./min) and brought again to 200° C. (5° C./min). The T_{g} values were evaluated using—unless indicated otherwise—the average of the second heating phase.

The polymer samples of polyphenyl methacrylate, poly(t-butyl methacrylate), polycyclohexyl acrylate and styrene from Experiments B were heated to 200° C. at 15° C. per minute and then cooled to −50° C. (−15° C./min), a temperature which was held for 10 minutes. The sample is then heated again to 200° C. (15° C./min), thereafter cooled to −50° C. (−15° C./min) and brought again to 200° C. (15° C./min).

The T_{g} values were evaluated using—unless indicated otherwise—the average of the second heating phase.

¹²M. Malanga, Adv. Mater., 2000, 12, 1869.

1. A process for preparing a polymer having isotactic or syndiotactic regions (ordered regions for short) by polymerizing polymerizable compounds (monomers) in the presence of an optically active compound as complexing agent, wherein
more than 50% by weight of the optically active compound is in the form of only one of the possible enantiomers,
the polymerization takes place at temperatures below 20° C., and
at least 10% by weight of the monomers are prochiral compounds.

2. The process as claimed in claim 1, wherein the complexing agent surrounds the monomers in the complex.

3. The process as claimed in claim 1, wherein the entire complexing agent is in the form of just one of the possible enantiomers.

4. The process as claimed in claim 1, wherein the complexing agent is cyclodextrin or a non cyclic polysaccharide.

5. The process as claimed in claim 1, wherein at least 50% by weight of the monomers to be polymerized are monomers having a solubility of less than 20 g of monomer per liter of water.

6. The process as claimed in claim 1, wherein the polymerization takes place in water, water-miscible solvents or mixtures thereof.

7. The process as claimed in claim 1, wherein the polymerization takes place at temperatures below 0° C., in the presence or absence of auxiliaries which lower the freezing point of the solvent or solvent mixture used.

8. The process as claimed in claim 1, wherein the weight-average molecular weight, Mw, of the polymers obtained is from 5000 to 500000 g/mol, measured by gel permeation chromatography.

9. The process as claimed in claim 1, wherein the weight-average molecular weight, Mw, of the polymers obtained is at least 1 million, measured by gel permeation chromatography.

10. The process as claimed in claim 1, wherein the polymer in differential thermal analysis has at least two glass transition temperatures (frozen-in glass state/liquid transition) or at least one glass transition temperature and one melting point (crystalline/liquid transition).

11. The process as claimed in claim 1, wherein the fraction of the ordered regions amounts to from 0.1 to 90% by weight of the total polymer.

12. A polymer obtained by a process as claimed in claim 1.

13-14. (canceled)

15. A paint or a leather coating comprising the polymer as claimed in claim 12.

16. A method for producing a paint or a leather coating comprising adding the polymer as claimed in claim 13 to a paint or a leather coating formulation.

17. A detergent additive comprising the polymer as claimed in claim 12.

18. A scale inhibitor comprising the polymer as claimed in claim 12.

19. A dispersant comprising the polymer as claimed in claim 12.

20. A method for producing a detergent comprising adding the detergent additive as claimed in claim 17 to a detergent formulation.

21. A method for producing a scale polymer inhibitor comprising adding the polymer as claimed in claim 12 to a scale inhibitor formulation.

22. A method for producing a dispersant comprising adding the polymer as claimed in claim 12 to a dispersant formulation.
